(19) United States
(12) Patent Application Publication
(10) Pub. No.: US 2010/0262355 A1
(43) Pub. Date: Oct. 14, 2010

(54) METHOD AND DEVICE FOR EXAMINING A VALVE LIFT SWITCHING PROCESS

(76) Inventors: Erwin Bauer, Lappersdorf (DE); Dietmar Ellmer, Regensburg (DE)

Correspondence Address: King & Spalding LLP, 401 Congress Avenue, Suite 3200, Austin, TX, 78701, US

(21) Appl. No.: 12/741,233

(22) PCT Filed: Oct. 21, 2008
(86) PCT No.: PCT/EP08/64162

§ 371 Date: Jun. 30, 2010

(30) Foreign Application Priority Data
Nov. 8, 2007 (DE) 10 2007 053 257.3

(51) Int. Cl. F02D 41/00

(52) U.S. Cl. 701/103

(57) ABSTRACT

In a method and a device for examining a valve lift switching process in a motor vehicle the occurrence or the number of switching errors is reduced. The method has the steps of detecting whether a switching error and/or an external event occurs that may influence the mode of operation of the valve lift switching; blocking the valve lift switching if a switching error and/or an external event has occurred; activating and examining the valve lift switching during at least one uncritical operating condition; releasing the valve lift switching if the valve lift switching does not show any abnormalities during monitoring.

### CROSS-REFERENCE TO RELATED APPLICATIONS

This application is a U.S. National Stage Application of International Application No. PCT/EP2008/064162 filed Oct. 21, 2008, which designates the United States of America, and claims priority to German Application No. 10 2007 053 257.3 filed Nov. 8, 2007, the contents of which are hereby incorporated by reference in their entirety.

### TECHNICAL FIELD

The invention relates to a method and a device for checking a valve lift switchover process in a motor vehicle.

### BACKGROUND

Electrohydraulic valve lift switchover systems are generally known from the prior art. An example of an electrohydraulic valve lift switchover system is the VARIO CAM PLUS system of the company INA. This is a two-stage valve lift switchover system in which a locking element is actuated in a control bucket tappet or a rocker arm by means of oil pressure against a spring and by this means, depending on the activation or deactivation status, it is possible to switch between two different valve lift curves. To effect the switchover an electromagnetic valve (3/2-way valve) located in the oil circuit is supplied with current, whereupon the valve opens. The oil pressure builds up and the locking element moves against the spring until the locking operation is completed. When the electromagnetic valve is closed again, the oil pressure decreases via a leakage line and the locking element, activated by the spring force, slides back into its home position.

In order to guarantee a comfortable, jerk-free and emission-neutral switchover it must be ensured that the locking process takes place in a defined operating segment that is known to the engine control unit, since measures that accompany the valve lift switchover, such as the adjustment of the throttle valve and the camshaft phasers as well as the adjustment of ignition and injection, must be performed at the right time or, as the case may be, in the right segment. This plays an all the more important role if a changeover in operating mode is initiated simultaneously with the valve lift switchover, for example from an SI (Spark Ignited) operating mode into a CAI (Controlled Auto-Ignition) operating mode in which a homogeneous self-ignition takes place. The system is extremely complex and the multiplicity of influencing variables inevitably harbors the risk of switchover errors.

### SUMMARY

According to various embodiments, a method and a device can be provided which reduce the occurrence or number of switchover errors.

According to an embodiment, a method for checking a valve lift switchover of an engine may comprise the steps of: a) determining whether a switchover error and/or an external event has occurred which can affect the correct operation of the valve lift switchover function, b) inhibiting the valve lift switchover if a switchover error and/or such an external event has occurred, c) activating and checking the valve lift switchover during at least one noncritical operating state, d) releasing the valve lift switchover if the valve lift switchover exhibits no abnormalities during the check.

According to a further embodiment of the method, step a) may have the step of: a1) setting at least one flag in an engine control unit for controlling the valve lift switchover when a switchover error and/or an external event has occurred. According to a further embodiment of the method, the information that an external event has occurred can be forwarded to the engine control unit, for example via a diagnostic line, a CAN data line, a LIN data line or another suitable interface. According to a further embodiment of the method, at step b) the valve lift switchover may be inhibited for all operating states. According to a further embodiment of the method, at step d) the valve lift switchover can be released for all operating states if the valve lift switchover exhibits no abnormalities during the check. According to a further embodiment of the method, a noncritical operating state may include, for example, operating states such as a deceleration fuel cutoff phase or operating points in which essentially no torque jump or only a slight torque jump is to be expected during the valve lift switchover. According to a further embodiment of the method, at step c) the checking of the valve lift switchover can be performed in a noncritical operating state in that, for example, a switch is made back and forth between two camshaft profiles at least once or a number of times, the valve lift switchover being checked each time for correct operation in the process, its operation being analyzed, for example, on the basis of at least one or more than one parameter, such as the oil pressure curve, the switching timing, the switching sequence, the cylinder pressure curve, etc. According to a further embodiment of the method, at step d) the valve lift switchover can be released for all operating states if the valve lift switchover exhibits no abnormalities during the check. According to a further embodiment of the method, if it is established during the checking of the valve lift switchover at step c) that the valve lift switchover is exhibiting abnormalities during the check, at least one or more than one control parameter can be adjusted accordingly in order to substantially remove the abnormalities in the valve lift switchover, one control parameter relating, for example, to the control of the switching timing. According to a further embodiment of the method, if an adjustment of at least one or more than one control parameter was made, the valve lift switchover may be subsequently activated initially only for at least one noncritical operating state and a check of the valve lift switchover is performed in said operating state. According to a further embodiment of the method, an external event which can affect the correct operation of the valve lift switchover function may include, for example, at least one of the following events or combination of events or, as the case may be, input variables: an oil temperature, an oil change, a visit to a repair shop in conjunction with, for example, work on the valve train assembly, work on components relevant to the valve lift switchover, the replacement of components relevant to the valve lift switchover, work on the oil circuit, for example the oil pump, the filter, the lines, etc.

According to a further embodiment, a device for checking a valve lift switchover of an engine may have: a) an arrangement for determining whether a switchover error and/or an external event has occurred which can affect the correct operation of the valve lift switchover function, b) an arrangement for inhibiting the valve lift switchover, the arrangement inhibiting the valve lift switchover if a switchover error and/or such an external event was detected by the arrangement for detecting a switchover error or an external event, c) an activation and checking arrangement which activates the valve lift switchover for at least one noncritical operating state and checks it during said operating state, the activation and checking arrangement releasing the valve lift switchover if the valve lift switchover exhibits no abnormalities during the check.

According to a further embodiment of the device, the arrangement for determining whether a switchover error and/or an external event has occurred which can affect the correct operation of the valve lift switchover can be connected to an engine control unit and sets a flag if a switchover error or an external event occurs, the arrangement being connected for this purpose to the engine control unit via, for example, a diagnostic line, a CAN data line, a LIN data line or another suitable interface. According to a further embodiment of the device, if the activation and checking arrangement establishes during the checking of the valve lift switchover that the valve lift switchover is exhibiting abnormalities during the check, an adjustment arrangement for adjusting control parameters may adjust at least one or more than one control parameter accordingly in order to substantially remove the abnormalities in the valve lift switchover. According to a further embodiment of the device, the control arrangement may control, for example, the switching timing as a control parameter.

### BRIEF DESCRIPTION OF THE DRAWINGS

The invention is now explained in more detail with reference to the attached drawing, in which:

FIG. 1 shows a flowchart of the valve lift switchover according to various embodiments.

### DETAILED DESCRIPTION

According to various embodiments, a check is performed on a valve lift switchover of an engine, wherein it is determined initially whether a switchover error and/or an external event have/has occurred which can affect the correct operation of the valve lift switchover function. If at least one of said events occurs, the valve lift switchover is initially disabled or inhibited. Subsequently the valve lift switchover is activated in a noncritical state and checked. If the result of the check is that the valve lift switchover exhibits no abnormalities during the noncritical operating state, the valve lift switchover is enabled or released once more.

This has the advantage that the occurrence and number of switchover errors can be reduced by virtue of the fact that a check of the valve lift switchover takes place at an early stage, when, for example, a first switchover error has occurred. In this case the valve lift switchover is allowed or activated only in a noncritical operating state, whereas the valve switchover is blocked in the other operating states. In this way the occurrence of further switchover errors can be prevented.

In a further embodiment, the valve lift switchover is inhibited for all operating states if a switchover error occurs or an external event is present which can potentially affect the valve lift switchover in a negative manner. In this way it can be ensured that, for example, no further switchover errors can occur until it has been clarified whether a (single) switchover error that occurred was coincidence or whether an error is present in the valve lift switchover.

In a further embodiment, the valve lift switchover is released again for all operating states, including also for the critical operating states if it has been established during the check that the valve lift switchover has exhibited no abnormalities. It is thus ensured that when the check has been completed and no functional errors have been revealed the valve lift switchover can be performed again to the full extent.

According to a further embodiment, a noncritical operating state includes, for example, operating states such as a deceleration fuel cutoff phase or operating points in which essentially no torque jump or only a slight torque jump is likely during the valve lift switchover. Such operating states have the advantage that a check or testing of the valve lift switchover can be performed so as to be scarcely noticeable to the driver, for example, with the result that the driver's driving experience is not adversely affected by the check.

In another embodiment, a check of the valve lift switchover is performed, for example, by switching back and forth between two camshaft profiles at least once or a number of times. In this case the valve lift switchover function is checked each time in respect of its correct operation, the latter being determined, for example, on the basis of at least one or more than one parameter, such as the oil pressure curve, the switching timing, the switching sequence and/or the cylinder pressure curve. In this way it can be easily and reliably determined whether an actual error is present during the valve lift switchover or not.

In a further embodiment, if, during the checking of the valve lift switchover, it is established that the valve lift switchover exhibits abnormalities during the check, at least one parameter is adjusted in order to substantially remove the abnormalities in the valve lift switchover. For example, if it is established that the valve lift switchover takes place too early or too late, the switching timing, for example, is correspondingly adjusted as the parameter. In this way it is possible not only to determine an error in the valve lift switchover, but also to rectify said error during the operation of the vehicle.

In another embodiment, following an adjustment of the parameter or parameters the valve lift switchover is initially activated only for at least one noncritical operating state and a new check of the valve lift switchover is performed. If the valve lift switchover thereafter no longer exhibits any abnormalities, the valve lift switchover can be released for all operating states. In this way it can be ensured that a valve lift switchover is enabled only when the error has been reliably removed. Otherwise a fresh adjustment of at least one parameter is carried out. In this case this cycle can be repeated a number of times if necessary before, after a specific number of cycles for example, an error message is issued to the driver in which it is stated that an error has occurred during the valve lift switchover and the driver should seek out a repair shop since the error cannot be corrected.

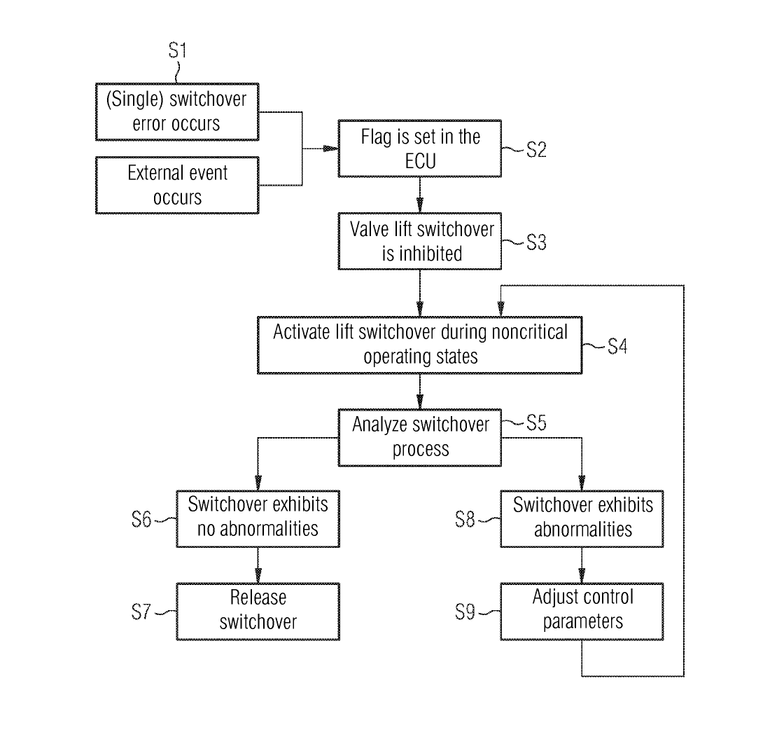

FIG. 1 shows a flowchart for performing a valve lift switchover. In this case it is initially determined at a step S1 whether a (single) switchover error has occurred and/or whether another event is present which is having an effect on the valve lift switchover process.

In the case of such potential influencing variables a distinction is made, for example, between engine-internal and external influencing variables. Engine-internal influencing variables affecting the valve lift switchover process which can cause a (single) switchover error are, for example:

Oil temperature, oil foaming, oil thinning by fuel, occurrence of a leak, occurrence of wear and tear, aging, running-in effects of system components, deposits in the oil galleries, a blocked or clogged oil filter, etc.

With the exception of, say, the oil temperature, most of the aforementioned influencing variables are largely variables that are unknown to the engine control unit. Their effect on the valve lift switchover usually does not manifest itself until a switching error actually occurs.

Furthermore, external influencing variables affecting the valve lift switchover or external events which can have a negative effect on the valve lift switchover are, for example, the following:
an oil change
a visit to the repair shop in conjunction with: work on the valve train assembly and/or components relevant to the valve lift switchover, replacement of components relevant to the valve lift switchover, work on the oil circuit, for example the oil pump, the filter, the lines, etc.

When such work is carried out on the engine, this information is communicated to the engine control unit (ECU). This is accomplished via, for example, one or more diagnostic lines (K line), CAN buses, LIN buses or via other suitable interfaces.

At a step S2, a marker or flag is therefore set in the engine control unit (ECU) if a switchover error occurs or if at least one external event occurs which can have an effect, i.e. a negative effect, on the valve lift switchover process.

If it is reported to the engine control unit (ECU), for example, that work has been carried out on the valve lift switchover, a marker or flag “work carried out on the valve lift switchover” is set. As soon as the flag has been set at step S2 the valve lift switchover is blocked as a preventive measure at a next step S3. The same applies if a switching error occurs; the latter can likewise be reported to the engine control unit and a marker or flag set.

Next, at a step S4, the valve lift switchover is activated only during noncritical operating states, while remaining blocked during critical operating states. At a step S5, the switchover is tested for problem-free operation in the noncritical driving operating states and diagnosed.

A noncritical operating state is, for example, the deceleration fuel cutoff phase, in which a driver takes his/her foot off the accelerator pedal, for example. In the deceleration fuel cutoff phase essentially no active torque is demanded of the engine and substantially no fuel is injected. Further noncritical operating states arise, for example, in operating points at which essentially no torque jump or only a slight torque jump is to be expected during the valve lift switchover. In other words, in such operating points there is virtually or substantially torque neutrality. In said states a switchover is made back and forth between two camshaft profiles, for example, at least once or if possible a number of times and in the process the valve lift switchover function is checked in respect of its correct operation. The effect of the different valve lift curves on the engine braking torque and the impact on driving comfort during the cutoff phase are largely negligible or, as the case may be, can be eliminated through adjustment of the throttle valve setting, with the result that the driver experiences no unpleasant driving sensation due to the check.

If no abnormalities in the valve lift switchover manifest themselves during the testing or checking phase (step S6), it is to be assumed that the external event that occurred, in the present example the work on the valve lift switchover, has no negative effect on the switching system. This applies analogously if, for example, a switching error occurred previously. If it is established in this case that no abnormalities have arisen during the testing phase either, it is assumed that the switching error that occurred was coincidental.

At a step S7, the valve lift switchover function is thereupon released again for all engine operating states, including also for the critical operating states.

If, on the other hand, it is established at step S8 that abnormalities in the switchover manifest themselves during the testing and checking of the switchover function for problem-free operation in the noncritical driving operating states, suitable measures are taken at a step S9.

In other words, if an anomalous behavior manifests itself during the valve lift switchover (step S8), for example in the form of, say, a change in oil pressure buildup or decrease, a change in the switching timing, a change in the cylinder pressure buildup, or a change in the switchover sequence of the cylinders, etc., then measures must be taken. The same applies if the supposed switchover error occurs repeatedly. In this case a measure is taken at step S9 in that at least one or more than one parameter relevant to the valve lift switchover or at least one or more than one control parameter are adjusted or adapted.

If the valve lift switchover takes place too early or too late during the check, the switching timing, for example, is adjusted as the parameter in order to correct the valve lift switchover in a suitable manner so that it no longer manifests abnormalities during a next check. If, on the other hand, it is established during the checking of the valve lift switchover, for example, that no valve lift switchover has taken place at all, even though such a switchover should have taken place in the noncritical operating state, then the valve lift switchover remains blocked, since in this case an error is present which it is no longer possible to rectify by means of an adjustment of the switching timing.

Furthermore an error pattern of the cylinders can also be analyzed during the checking of the valve lift switchover. If, for example, a valve lift switchover always occurs late in the case of the same cylinder, the sequence of the cylinders during switching, for example, can be changed as the parameter. In this case the cylinder can now be controlled in such a way that it has more time for switching, for example, in that it is switched, not as the first, but as the last cylinder. If the error occurs again at the next checking step, in spite of a previous adjustment of the cylinder switching sequence, it can be inferred from this that an error is present at the cylinder. In this case a warning signal can be output to the driver indicating that the valve lift switchover is defective and he/she should visit a repair shop.

Furthermore the error can additionally be stored so that it can be retrieved and analyzed in a repair shop, for example.

After adjustment of at least one control parameter relevant to the valve lift switchover at step S9, the flowchart therefore returns to step S4, at which the valve lift switchover is initially activated again only during noncritical operating states. At the following step S5, the switchover process is tested and checked once again. Only if the result of the testing and checking is that the switchover exhibits no abnormalities is the valve lift switchover released for all operating states at step S7. Otherwise control parameters relevant to the valve lift switchover must continue to be adjusted (step S9). In this case the step of checking and readjustment can be performed a predefined number of times. If an abnormality of the valve lift switchover then still continues to occur, a warning signal can be output to the driver. In this way it is possible to prevent constant adjustments being made even though an error is present which cannot be rectified by means of an adjustment alone, but where, for example, it is necessary to visit a repair shop. In this case this can be communicated to the driver in good time.

According to the above-described method, the engine control unit can be connected to at least one sensor or to a plurality of sensors which detect a switchover error. Furthermore, as has already been described in the foregoing, the engine control unit is notified via a suitable interface if an external event occurs which can adversely affect the correct operation of the valve lift switchover function. For that purpose the engine control unit can have a corresponding arrangement by means of which it is determined whether a switchover error has been detected by the sensor or sensors or whether an external event has occurred. The valve lift switchover can then be blocked accordingly via the engine control unit, preferably for all operating states. Furthermore the engine control unit can activate the valve lift switchover only for at least one or for more than one noncritical operating state in order to perform a check of the valve lift switchover process. If the engine control unit establishes in so doing that the valve lift switchover is exhibiting abnormalities in the respective noncritical operating state, it can adapt or adjust parameters in a suitable manner in order to remove the abnormalities in the valve lift switchover in an appropriate manner, as described in detail hereintofore.

The advantage of the method according to various embodiments and of the device is essentially that following an external intervention (e.g. engine oil change, work on the valve lift switchover, etc.) or, as the case may be, following a single switching error, the system is afforded the opportunity to perform a self-test and if necessary to make adaptations or adjustments. The risk of a (serious) switching error is in this way reduced to a minimum. Furthermore driver and occupants are not adversely affected by any losses in comfort, since the check is performed in noncritical operating states.

What is claimed is:

1. A method for checking a valve lift switchover of an engine, comprising the steps of:
a) determining whether at least one of a switchover error an external event has occurred which can affect the correct operation of the valve lift switchover function,
b) inhibiting the valve lift switchover if at least one of a switchover error such an external event has occurred,
c) activating and checking the valve lift switchover during at least one noncritical operating state,
d) releasing the valve lift switchover if the valve lift switchover exhibits no abnormalities during the check.

2. The method according to claim 1, wherein step a) has the step of:
a1) setting at least one flag in an engine control unit for controlling the valve lift switchover when at least one of a switchover error and/or an external event has occurred.

3. The method according to claim 2, wherein the information that an external event has occurred is forwarded to the engine control unit.

4. The method according to claim 1, wherein at step b) the valve lift switchover is inhibited for all operating states.

5. The method according to claim 1, wherein at step d) the valve lift switchover is released for all operating states if the valve lift switchover exhibits no abnormalities during the check.

6. The method according to claim 1, wherein a noncritical operating state includes operating states selected from the group consisting of: a deceleration fuel cutoff phase and operating points in which essentially no torque jump or only a slight torque jump is to be expected during the valve lift switchover.

7. The method according to claim 1, wherein at step c) the checking of the valve lift switchover is performed in a noncritical operating state in that a switch is made back and forth between two camshaft profiles at least once or a number of times, the valve lift switchover being checked each time for correct operation in the process, and its operation being analyzed, on the basis of at least one or more than one parameter.

8. The method according to claim 1, wherein
at step d) the valve lift switchover is released for all operating states if the valve lift switchover exhibits no abnormalities during the check.

9. The method according to claim 1, wherein if it is established during the checking of the valve lift switchover at step c) that the valve lift switchover is exhibiting abnormalities during the check, at least one or more than one control parameter will be adjusted accordingly in order to substantially remove the abnormalities in the valve lift switchover.

10. The method according to claim 9, wherein if an adjustment of at least one or more than one control parameter was made, the valve lift switchover is subsequently activated initially only for at least one noncritical operating state and a check of the valve lift switchover is performed in said operating state.

11. The method according to claim 1, wherein an external event which can affect the correct operation of the valve lift switchover function includes at least one of the following events or combination of events or, as the case may be, input variables selected from the group: an oil temperature, an oil change, a visit to a repair shop in conjunction with work on the valve train assembly or work on components relevant to the valve lift switchover or the replacement of components relevant to the valve lift switchover, work on the oil circuit.

12. A device for checking a valve lift switchover of an engine, the device comprising:
a) an arrangement for determining whether at least one of a switchover error an external event has occurred which can affect the correct operation of the valve lift switchover function,
b) an arrangement for inhibiting the valve lift switchover, the arrangement inhibiting the valve lift switchover if at least one of a switchover error and/or such an external event was detected by the arrangement for detecting a switchover error or an external event,
c) an activation and checking arrangement which activates the valve lift switchover for at least one noncritical operating state and checks it during said operating state, the activation and checking arrangement releasing the valve lift switchover if the valve lift switchover exhibits no abnormalities during the check.

13. The device according to claim 12, wherein the arrangement for determining whether at least one of a switchover error an external event has occurred which can affect the correct operation of the valve lift switchover is connected to an engine control unit and sets a flag if a switchover error or an external event occurs, the arrangement being connected for this purpose to the engine control unit.

14. The device according to claim 12, wherein if the activation and checking arrangement establishes during the checking of the valve lift switchover that the valve lift switchover is exhibiting abnormalities during the check, an adjustment arrangement for adjusting control parameters adjusts at least one or more than one control parameter accordingly in order to substantially remove the abnormalities in the valve lift switchover.

15. The device according to claim 14, wherein the control arrangement controls the switching timing as a control parameter.

16. The device according to claim 13, wherein the arrangement being connected to the engine control unit via a diagnostic line, a CAN data line, a LIN data line or another suitable interface.

17. The method according to claim 3, wherein the information is forwarded via a diagnostic line, a CAN data line, a LIN data line or another suitable interface.

18. The method according to claim 7, wherein the at least one or more than one parameter is the oil pressure curve, the switching timing, the switching sequence, or the cylinder pressure curve.

19. The method according to claim 9, wherein the one control parameter relates to the control of the switching timing.

20. The method according to claim 11, wherein the oil circuit includes at least one of the oil pump, the oil filter, and the oil lines.
